(19) United States
(12) Patent Application Publication
(10) Pub. No.: US 2016/0111714 A1
(43) Pub. Date: Apr. 21, 2016

(54) ANODE ACTIVE MATERIAL AND SECONDARY BATTERY COMPRISING THE SAME

(71) Applicant: OCI COMPANY LTD., Seoul (KR)

(72) Inventors: Hyun-Wook LEE, Seongnam-si (KR); Kwang-Eui YOON, Seongnam-si (KR); Young-Seok SONG, Seongnam-si (KR); Eun-Hye JEONG, Seongnam-si (KR)

(21) Appl. No.: 14/877,937

(22) Filed: Oct. 8, 2015

(30) Foreign Application Priority Data
Oct. 17, 2014 (KR) 10-2014-0140886

(51) Int. Cl. H01M 4/36; H01M 4/133; H01M 4/46; H01M 4/38; H01M 4/42; H01M 4/137; H01M 4/134

(52) U.S. Cl. CPC H01M 4/364; H01M 4/137; H01M 4/366; H01M 4/133; H01M 4/134; H01M 4/38; H01M 4/387; H01M 4/42; H01M 4/386; H01M 4/463; H01M 2004/027

(57) ABSTRACT

Disclosed herein are an anode active material and a secondary battery comprising the same, and more specifically, an anode active material comprising a graphite carbon material coated with an amorphous carbon material comprising metal particles, and a secondary battery comprising the same.

### CROSS REFERENCE TO RELATED APPLICATION

This application claims the benefit of Korean Patent Application No. 10-2014-0140886, filed on Oct. 17, 2014, entitled “ANODE ACTIVE MATERIAL AND SECONDARY BATTERY COMPRISING THE SAME”, which is hereby incorporated by reference in its entirety into this application.

### TECHNICAL FIELD

The present invention relates to an anode active material and a secondary battery comprising the same, and more specifically, to an anode active material comprising a graphite carbon material coated with an amorphous carbon material comprising metal particles, and a secondary battery comprising the same.

### BACKGROUND ART

As various portable electronic devices such as video cameras, wireless telephone, mobile phones, notebook computers, and the like, come into wide use, demand for a secondary battery used as a power supply has been largely increased. Among the secondary batteries, lithium secondary battery has excellent battery properties of large capacity and high energy density, and therefore, the lithium secondary battery has been the most widely used at present.

The lithium secondary battery basically comprises a cathode, an anode, and an electrolyte. Here, a graphite carbon material such as natural graphite used as an anode material of the lithium secondary battery has large reversible capacity and excellent initial charge and discharge efficiency, but reduced output characteristics. In particular, an electrolyte decomposition reaction at an edge of high crystalline graphite carbon material is considered as a reason of the reduced output characteristics. In addition, unlike the graphite carbon material, an amorphous carbon material as an anode material has excellent output characteristics, but has large irreversible capacity and reduced charge and discharge efficiency.

Accordingly, a research for obtaining the advantages of the graphite carbon material and the amorphous carbon material has continued in the art.

### DISCLOSURE

### Technical Problem

An aspect of the present invention is to provide an anode active material having excellent reversible capacity, charge and discharge efficiency, and output characteristics as compared to the existing anode active materials.

More specifically, the aspect of the present invention is to improve reversible capacity, charge and discharge efficiency, and output characteristics of a secondary battery by providing the anode active material comprising a graphite carbon material coated with an amorphous carbon material comprising metal particles.

### Technical Solution

In accordance with one aspect of the present invention, an anode active material comprises: a graphite carbon material; and a coating layer in which an amorphous carbon material comprising metal particles is coated on a surface of the graphite carbon material, wherein contents of the metal particles, a primary quinoline insoluble material, and ash comprised in the amorphous carbon material satisfy Equation 1 below:

$$3.7 < 1 oz ( \frac{M ( wt \% ) \times 60}{QI ( wt \% ) \times Ash ( Wt \% )} ) < 9.18 \\ ( M \text{:} Metal Particle , QI \text{:} Primary Quinoline Insoluble Material ) . \qquad [ Equation 1 ]$$

The graphite carbon material may be one selected from the group consisting of natural graphite, artificial graphite, graphitized coke, graphitized carbon fiber, graphitized mesocarbon microbead, and any mixtures thereof.

The coating layer may be formed by dispersing the metal particles in the amorphous carbon material.

The metal particle may be one selected from the group consisting of chromium, tin, silicon, aluminum, nickel, zinc, cobalt, manganese and any mixtures thereof.

The metal particle may have a diameter of 20 nm to 100 nm.

The metal particles may be dispersed in the amorphous carbon material by using a dispersant, the dispersant being selected from the group consisting of polyacrylic acid, polyacrylate, polymethacrylic acid, polymethyl methacrylate, polyacrylamide, carboxymethyl cellulose, polyvinyl acetate, polymaleic acid, polyethylene glycol, polyvinyl-based resins and any copolymers thereof.

The metal particles may be dispersed in the amorphous carbon material by using a block copolymer comprising blocks having high affinity with the metal particles and blocks having low affinity with the metal particles.

The amorphous carbon material may be one selected from the group consisting of petroleum pitch, coal pitch, chemical pitch, and any mixtures thereof.

The content of the ash of the amorphous carbon material may be less than 0.05 wt %.

The contents of the metal particles and the amorphous carbon material may be 1 wt % to 30 wt %, based on the graphite carbon material.

In accordance with another aspect of the present invention, there is provided an anode for a secondary battery in which an anode slurry is coated on an anode current collector, the anode slurry comprising the anode active material as described above; a binder; and a thickener.

In accordance with another aspect of the present invention, there is provided a secondary battery comprising the anode for a secondary battery as described above.

### Advantageous Effects

The anode active material according to the present invention comprises a graphite carbon material coated with an amorphous carbon material comprising metal particles, wherein reversible capacity, charge and discharge efficiency, and output characteristics of the secondary battery may be significantly improved by strictly controlling contents of metal particles, a primary quinoline insoluble material, and ash comprised in the amorphous carbon material of the anode active material.

### DESCRIPTION OF DRAWINGS

FIG. 1 schematically illustrates a cross section of an anode active material according to an exemplary embodiment of the present invention.

### BEST MODE

Specific terms are defined herein so as to easily understand the present invention. Unless scientific and technical terms used herein are defined otherwise, they have meanings which are generally understood by those skilled in the art to which the present invention pertains. In addition, unless the context specifically indicates otherwise, the singular forms are intended to include the plural forms, and it is further understood that the plural forms also include the singular forms thereof.

Hereinafter, various exemplary embodiments of the present invention will now be described in detail.

Anode Active Material

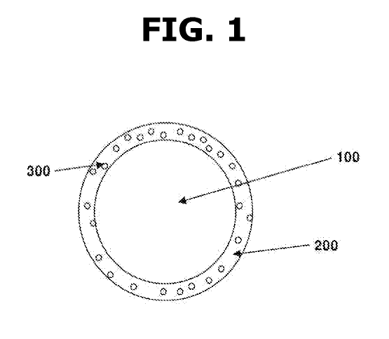

According to an exemplary embodiment of the present invention, there is provided an anode active material comprising: a graphite carbon material 100; and a coating layer 200 coated on a surface of the graphite carbon material 100. FIG. 1 schematically illustrates a cross section of the anode active material.

Here, as the graphite carbon material 100, natural graphite, artificial graphite, graphitized coke, graphitized carbon fiber, graphitized mesocarbon microbead, and any mixtures thereof may be used, and other graphite carbons in addition to the above-described examples of the graphite carbon material may also be used.

The graphite carbon material 100 may have a plate shape or a section shape. The graphite carbon material 100 may have a plate shape or a section shape, such that a plurality of carbon materials may be easily connected to each other to form a strong core material. In addition, the graphite carbon material 100 may have a spherical shape or a spherical-like shape, and may have a diameter of 5 to 30 μm. The coating layer coated on the surface of the graphite carbon material 100 has a thickness of about 3 μm, and accordingly, the graphite carbon material 100 preferably has a diameter of at least about 5 μm. In addition, the spherical graphite carbon material 100 is manufactured by spheroidizing plate graphite having a diameter of about 100 μm, and accordingly, the graphite carbon material 100 preferably has the maximum diameter of 30 μm in order to simplify a manufacturing process.

The coating layer 200 is formed on the surface of the graphite carbon material 100, wherein the coating layer 200 comprises an amorphous carbon material comprising the metal particles 300. More specifically, the coating layer 200 is formed by dispersing the metal particles in the amorphous carbon material.

First, the amorphous carbon material comprised in the coating layer 200 will be more specifically described.

The amorphous carbon material comprises low crystalline or amorphous carbon material. For example, the amorphous carbon material may be selected from the group consisting of petroleum pitch, coal pitch, chemical pitch, and any mixtures thereof.

The amorphous carbon material has a softening point of 150° C. to 280° C., and a primary quinoline insoluble material preferably has a content of 0.001 wt % to 0.2 wt %. In addition, the amorphous carbon material preferably comprises ash having a content less than 0.05 wt %.

The softening point indicates a temperature in which pitch becomes to have ductility. When the softening point of the amorphous carbon material is less than 150° C., the amorphous carbon material has an excessively high ductility at the time of coating the amorphous carbon material on the surface of the graphite carbon material 100 or at room temperature, which is not appropriate for being coated. In addition, when the softening point of the amorphous carbon material is more than 280° C., a temperature for exhibiting the ductility is excessively high, thereby causing an increase in manufacturing cost.

The primary quinoline insoluble material means a material which is insoluble to a quinoline solvent, generated at the time of producing coal tar, and a secondary quinoline insoluble material means a mesophase material generated during the reaction, and the primary quinoline insoluble material and the secondary quinoline insoluble material are differentiated from each other. The primary quinoline insoluble material is a material having a significantly large molecular weight, which causes reduction in growth of carbon tissue in a carbonization process. Accordingly, the content of the primary quinoline insoluble material needs to be controlled to be 0.2 wt % or less.

In generally, an anode active material formed by carbon materials comprises ash, wherein the ash mainly corresponding to an inorganic material causes deterioration in charge and discharge capacity and efficiency of a secondary battery, and accordingly, the content of the ash needs to be controlled to be less than 0.05 wt %.

Further, a relationship between the contents of the primary quinoline insoluble material and the ash comprised in the amorphous carbon material and a content of the metal particles 300 to be described below preferably satisfies Equation 1 below:

$$3.7 < 1 oz ( \frac{M ( wt \% ) \times 60}{QI ( wt \% ) \times Ash ( Wt \% )} ) < 9.18 \\ ( M \text{:} Metal Particle , QI \text{:} Primary Quinoline Insoluble Material ) . \qquad [ Equation 1 ]$$

Equation 1 above is to determine the content of the metal particles 300 on the basis of the contents of the primary quinoline insoluble material and the ash comprised in the amorphous carbon material. In addition, Equation 1 above is to determine the content of the metal particles 300 for compensating properties (for example, improving output characteristics) of the amorphous carbon material deteriorated according to presence of the primary quinoline insoluble material and the ash comprised in the amorphous carbon material.

Accordingly, the content of the metal particles 300 comprised in the amorphous carbon material may be calculated by substituting the contents of the primary quinoline insoluble material and the ash comprised in the amorphous carbon material in Equation 1 above.

When a log value of Equation 1 above is 3.7 or less, an increase in output characteristics and in charge and discharge capacity is deteriorated. When a log value of Equation 1 above is 9.18 or more, a possibility of short-circuit between the metal particles 300 and the amorphous carbon material is rapidly increased.

The metal particles 300 may be one selected from the group consisting of chromium, tin, silicon, aluminum, nickel, zinc, cobalt, manganese and any mixtures thereof, preferably, silicon.

Here, the metal particles 300 are coated on the surface of the graphite carbon material 100 while being dispersed in the amorphous carbon material, wherein the dispersion of the metal particles 300 may be performed by using at least one dispersant selected from the group consisting of polyacrylic acid, polyacrylate, polymethacrylic acid, polymethyl methacrylate, polyacrylamide, carboxymethyl cellulose, polyvinyl acetate, polymaleic acid, polyethylene glycol, polyvinyl-based resins and any copolymers thereof. In addition, in another modified embodiment, the dispersion of the metal particles 300 may be performed by using a block copolymer dispersant comprising blocks having high affinity with the metal particles and blocks having low affinity with the metal particles.

Here, the blocks having high affinity with the metal particles are gathered toward a surface of the metal particles by van der Waals force, wherein examples of the blocks may include polyacrylic acid, polyacrylate, polymethacrylic acid, polymethyl methacrylate, polyacrylamide, carboxymethyl cellulose, polyvinyl acetate, poly maleic acid, and the like.

The blocks having low affinity with the metal particles are gathered toward an outer side by wan der Waals force, wherein examples of the blocks may include polystyrene, polyacrylonitrile, poly phenol, polyethylene glycol, poly lauryl methacrylate, polyvinyl difluoride, and the like.

The above-described dispersants together with the metal particles 300 may form a core-shell composite. For example, when the block copolymer comprising the blocks having high affinity with the metal particles and the blocks having low affinity with the metal particles is used as the dispersant, a copolymer shell of the blocks having high affinity with the metal particles and the blocks having low affinity with the metal particles is formed on the surface of the metal particles 300, thereby obtaining the core-shell composite having a spherical-shaped micelle structure. The core-shell composite formed of the metal particles 300 and the dispersant as described above may suppress a phenomenon that the metal particles 300 are agglomerated to each other in the amorphous carbon material.

A degree at which the metal particles 300 are dispersed in the amorphous carbon material may vary depending on a content, a diameter, and the like, of the metal particles 300. In addition, the content of the above-described dispersant may also vary depending on the content, the diameter, and the like, of the metal particles 300.

The content of the metal particles 300 is preferably 1 to 30 wt % based on a weight of the amorphous carbon material. A volume of the metal particles 300 is expanded or contracted depending on absorption or release of lithium at the time of charging or discharging a battery, wherein at the time of repeating a charge-discharge cycle, a short-circuit phenomenon between the carbon material and the metal particles 300 may occur. The short-circuit phenomenon may occur frequently when the metal particles 300 have an excessive content in the carbon material, and accordingly, the metal particles 300 are preferably comprises at a range of 1 to 30 wt % based on a weight of the amorphous carbon material.

In addition, the metal particle 300 preferably has a diameter of 20 nm to 100 nm. When the diameter of the metal particle 300 is excessively large (for example, more than 100 nm), it is difficult to form the core-shell composite with the above-described dispersant, or an excessive amount of dispersant needs to be added to achieve formation of the core-shell composite, which is not economical. Further, a volume of the metal particles 300 is expanded or contracted at the time of charging or discharging a battery, wherein as the diameter of the metal particle 300 is increased, a gap between the maximally expanded volume and the maximally contracted volume is large, and accordingly, the short-circuit phenomenon may relatively and seriously occur. Meanwhile, when the diameter of the metal particles 300 is excessively small (for example, less than 20 nm), absorption or release of lithium by silicon may not be sufficiently implemented.

The contents of the metal particles and the amorphous carbon material are preferably 1 to 30 wt %, based on the graphite carbon material 100. When the contents of the metal particles and the amorphous carbon material are less than 1 wt % based on the graphite carbon material 100, it is difficult to obtain an effect of improving output characteristics by the amorphous carbon material. Meanwhile, when the contents of the metal particles and the amorphous carbon material are more than 30 wt % based on the graphite carbon material 100, rather, irreversible capacity may be increased, and charge and discharge efficiency may be decreased.

Anode for Secondary Battery

According to another exemplary embodiment of the present invention, there is provided an anode for a secondary battery in which an anode slurry is coated on an anode current collector, the anode slurry comprising the anode active material as described above; a binder; and a thickener.

The anode for a secondary battery is formed by coating the anode slurry comprising the anode active material, the binder, and the thickener on the anode current collector, and performing a drying process and a rolling process.

As the binder, various kinds of binder polymers such as styrene-butadiene rubber (SBR), carboxymethyl cellulose (CMC), polyvinylidene fluoride-hexafluoropropylene copolymer (PVDF-co-HFP), polyvinylidenefluoride, polyacrylonitrile, polymethylmethacrylate, and the like, may be used. The thickener is to control viscosity, and may include carboxymethyl cellulose, hydroxymethyl cellulose, hydroxyethyl cellulose, hydroxypropyl cellulose, and the like, as examples. As the anode current collect, a stainless steel, nickel, copper, titanium, alloys thereof, or the like, may be used.

Secondary Battery

According to still another exemplary embodiment of the present invention, there is provided a secondary battery comprising the anode for a secondary battery as described above.

The secondary battery according to the present invention is characterized by comprising the anode comprising the above-described anode active material to have significantly improved reversible capacity, charge and discharge efficiency, and output characteristics.

The secondary battery is formed by comprising the anode for a secondary battery; a cathode comprising a cathode active material; a separator; and an electrolyte.

As materials used as the cathode active material, compounds capable of absorbing and releasing lithium, such as LiMn₂O₄, LiCoO₂, LiNIO₂, LiFeO₂, and the like, may be used.

As the separator insulating the electrodes between the anode and the cathode, olefin-based porous films such as polyethylene, polypropylene, and the like, may be used.

In addition, the electrolyte may be obtained by mixing and dissolving at least one electrolyte comprising a lithium salt in at least one aprotic solvent, wherein the lithium salt is selected from the group consisting of LiPF₆, LiBF₄, LiSbF₆, LiAsF₆, LiClO₄, LiCF₃SO₃, Li(CF₃SO₂)₂N, LiC₄F₉SO₃, LiSbF₆, LiAlO₄, LiAlCl₄, LiN(CₓF₂ₓ₊₁SO₂)(C_{y}F_{2y+1}SO₂) (provided that each of x and y is a natural number), LiCl, and LiI, and the aprotic solvent is selected from the group consisting of propylene carbonate, ethylene carbonate, butylene carbonate, benzonitrile, acetonitrile, tetrahydrofuran, 2-methyl tetrahydrofuran, γ-butyrolactone, dioxolane, 4-methyldioxolane, N,N-dimethylformamide, dimethylacetamide, dimethyl sulfoxide, dioxane, 1,2-dimethoxyethane, sulfolane, dichloroethane, chlorobenzene, nitrobenzene, dimethyl carbonate, methyl ethyl carbonate, diethyl carbonate, methyl propyl carbonate, methyl isopropyl carbonate, ethyl propyl carbonate, dipropyl carbonate, diisopropyl carbonate, dibutyl carbonate, diethylene glycol, and dimethyl ether.

A plurality of secondary batteries may be electrically connected to each other to provide a middle- or large-sized battery module or battery pack comprising the plurality of secondary batteries, wherein the middle- or large-sized battery module or the battery pack may be used as a power of at least any one middle- or large-sized device selected from power tools; electric vehicles comprising EV, hybrid electric vehicle (HEV), and plug-in hybrid electric vehicle (PHEV); electric trucks; electric commercial vehicles; or systems for energy storage.

Hereinafter, specific exemplary embodiments of the present invention will be provided. Meanwhile, Examples to be described below are just provided for specifically exemplifying or explaining the present invention, and accordingly, the present invention is not limited to the following Examples.

### Example 1

Coal pitch (96 g) having a softening point of 250° C. and comprising a primary quinoline insoluble material at a content of less than 0.05% was dissolved in NMP (150 ml), and then silicon particles were mixed in NMP so as to satisfy Equation: log((Si (wt %)×50%)/(QI (wt %)×Ash (wt %)))=6. The silicon particles in the coal pitch were dispersed by using acrylic acid as a dispersant, having an amount 10 times larger than the silicon particles, followed by stirring for 3 hours, and then NMP as a solvent was removed by distillation. The coal pitch (3 g) comprising the silicon particles was mixed with natural graphite (97 g) having an average diameter of 30 μm, and then the mixed coal pitch was coated on a surface of the natural graphite by using a mechanical stirrer. After the coating was completed, heat treatment at 1,100° C. was performed for 1 hour to finally prepare an anode active material.

### Example 2

Coal pitch (96 g) having a softening point of 250° C. and comprising a primary quinoline insoluble material at a content of less than 0.05% was dissolved in NMP (150 ml), and then silicon particles were mixed in NMP so as to satisfy Equation: log((Si (wt %)×50%)/(QI (wt %)×Ash (wt %)))=4. The silicon particles in the coal pitch were dispersed by using acrylic acid as a dispersant, having an amount 10 times larger than the silicon particles, followed by stirring for 3 hours, and then NMP as a solvent was removed by distillation. The coal pitch (3 g) comprising the silicon particles was mixed with natural graphite (97 g) having an average diameter of 30 μm, and then the mixed coal pitch was coated on a surface of the natural graphite by using a mechanical stirrer. After the coating was completed, heat treatment at 1,100° C. was performed for 1 hour to finally prepare an anode active material.

### Example 3

Coal pitch (96 g) having a softening point of 250° C. and comprising a primary quinoline insoluble material at a content of less than 0.05% was dissolved in NMP (150 ml), and then silicon particles were mixed in NMP so as to satisfy Equation: log((Si (wt %)×50%)/(QI (wt %)×Ash (wt %)))=9. The silicon particles in the coal pitch were dispersed by using acrylic acid as a dispersant, having an amount 10 times larger than the silicon particles, followed by stirring for 3 hours, and then NMP as a solvent was removed by distillation. The coal pitch (3 g) comprising the silicon particles was mixed with natural graphite (97 g) having an average diameter of 30 μm, and then the mixed coal pitch was coated on a surface of the natural graphite by using a mechanical stirrer. After the coating was completed, heat treatment at 1,100° C. was performed for 1 hour to finally prepare an anode active material.

### Comparative Example 1

Coal pitch (96 g) having a softening point of 110° C. and comprising a primary quinoline insoluble material at a content of less than 0.05% was dissolved in NMP (150 ml), and then silicon particles were mixed in NMP so as to satisfy Equation: log((Si (wt %)×50%)/(QI (wt %)×Ash (wt %)))=6. The silicon particles in the coal pitch were dispersed by using acrylic acid as a dispersant, having an amount 10 times larger than the silicon particles, followed by stirring for 3 hours, and then NMP as a solvent was removed by distillation. The coal pitch (3 g) comprising the silicon particles was mixed with natural graphite (97 g) having an average diameter of 30 μm, and then the mixed coal pitch was coated on a surface of the natural graphite by using a mechanical stirrer. After the coating was completed, heat treatment at 1,100° C. was performed for 1 hour to finally prepare an anode active material.

### Comparative Example 2

Coal pitch (96 g) having a softening point of 320° C. and comprising a primary quinoline insoluble material at a content of less than 0.05% was dissolved in NMP (150 ml), and then silicon particles were mixed in NMP so as to satisfy Equation: log((Si (wt %)×50%)/(QI (wt %)×Ash (wt %)))=6. The silicon particles in the coal pitch were dispersed by using acrylic acid as a dispersant, having an amount 10 times larger than the silicon particles, followed by stirring for 3 hours, and then NMP as a solvent was removed by distillation. The coal pitch (3 g) comprising the silicon particles was mixed with natural graphite (97 g) having an average diameter of 30 μm, and then the mixed coal pitch was coated on a surface of the natural graphite by using a mechanical stirrer. After the coating was completed, heat treatment at 1,100° C. was performed for 1 hour to finally prepare an anode active material.

### Comparative Example 3

Coal pitch (96 g) having a softening point of 240° C. and comprising a primary quinoline insoluble material at a content of less than 1% was dissolved in NMP (150 ml), and then silicon particles were mixed in NMP so as to satisfy Equation: log((Si (wt %)×50%)/(QI (wt %)×Ash (wt %)))=4. The silicon particles in the coal pitch were dispersed by using acrylic acid as a dispersant, having an amount 10 times larger than the silicon particles, followed by stirring for 3 hours, and then NMP as a solvent was removed by distillation. The coal pitch (3 g) comprising the silicon particles was mixed with natural graphite (97 g) having an average diameter of 30 μm, and then the mixed coal pitch was coated on a surface of the natural graphite by using a mechanical stirrer. After the coating was completed, heat treatment at 1,100° C. was performed for 1 hour to finally prepare an anode active material.

### Comparative Example 4

Coal pitch (96 g) having a softening point of 250° C. and comprising a primary quinoline insoluble material at a content of less than 0.05% was dissolved in NMP (150 ml), and then silicon particles were mixed in NMP so as to satisfy Equation: log((Si (wt %)×50%)/(QI (wt %)×Ash (wt %)))=2. The silicon particles in the coal pitch were dispersed by using acrylic acid as a dispersant, having an amount 10 times larger than the silicon particles, followed by stirring for 3 hours, and then NMP as a solvent was removed by distillation. The coal pitch (3 g) comprising the silicon particles was mixed with natural graphite (97 g) having an average diameter of 30 μm, and then the mixed coal pitch was coated on a surface of the natural graphite by using a mechanical stirrer. After the coating was completed, heat treatment at 1,100° C. was performed for 1 hour to finally prepare an anode active material.

### Comparative Example 5

Coal pitch (96 g) having a softening point of 250° C. and comprising a primary quinoline insoluble material at a content of less than 0.05% was dissolved in NMP (150 ml), and then silicon particles were mixed in NMP so as to satisfy Equation: log((Si (wt %)×50%)/(QI (wt %)×Ash (wt %)))=11. The silicon particles in the coal pitch were dispersed by using acrylic acid as a dispersant, having an amount 10 times larger than the silicon particles, followed by stirring for 3 hours, and then NMP as a solvent was removed by distillation. The coal pitch (3 g) comprising the silicon particles was mixed with natural graphite (97 g) having an average diameter of 30 μm, and then the mixed coal pitch was coated on a surface of the natural graphite by using a mechanical stirrer. After the coating was completed, heat treatment at 1,100° C. was performed for 1 hour to finally prepare an anode active material.

### Experimental Example

A composition for an anode slurry was prepared by mixing each of the anode active materials prepared by Examples and Comparative Examples above, carbon black (CB), carboxymethyl cellulose (CMC), and styrene butadiene (SBR) with water at a weight ratio of 91:5:2:2. The composition for an anode slurry was coated on a copper current collector, and dried and rolled in an oven at 110° C. for about 1 hour, to manufacture an anode for a secondary battery.

Next, a coin cell-type secondary battery was manufactured by sequentially stacking the anode for a secondary battery, a separator, an electrolyte (a solvent obtained by mixing ethylene carbonate with dimethyl carbonate at a weight ratio of 1:1, and adding 1.0M LiPF₆ thereto), and a lithium electrode.

Charge and discharge test was conduced on each of the manufactured secondary batteries according to the following conditions.

When it is assumed that 300 mA per 1 g is 1 C, charge conditions were controlled by a constant current at 0.2 C up to 0.01 V, and a constant voltage at 0.01 V up to 0.01 C, and discharge conditions were controlled by the constant current at 0.2 C up to 1.5V. An initial efficiency was exhibited as a retention rate of discharge capacity after 10 cycles as compared to an initial discharge capacity.

Charge and discharge capacity and initial efficiency measured in each of the secondary batteries were shown in the following Table 1.

TABLE 1

| | Charge and Discharge | |
|---|---|---|
| Classification | Capacity (mAh/g) | Initial Efficiency (%) |
| Example 1 | 392 | 87 |
| Example 2 | 363 | 90 |
| Example 3 | 402 | 83 |
| Comparative Example 1 | 335 | 87 |
| Comparative Example 2 | 347 | 89 |
| Comparative Example 3 | 387 | 75 |
| Comparative Example 4 | 335 | 91 |
| Comparative Example 5 | 419 | 62 |

According to Table 1 above, all of the secondary batteries of Examples 1 to 3 had charge and discharge capacity of 350 mAh/g or more, and also had high initial efficiency of 80% or more. Upon reviewing the results of the charge and discharge capacity and the initial efficiency of the secondary batteries of Comparative Examples, Comparative Examples 1, 2, and 4 had the initial efficiency similar to those of Examples; however, all of Comparative Examples 1, 2, and 4 had the charge and discharge capacity less than 350 mAh/g, which was lower than those of Examples. Comparative Examples 3 and 5 had the charge and discharge capacity similar to those of Examples; however, had the initial efficiency of 75% and 62%, respectively, which was lower than those of Examples.

That is, when the softening point of the amorphous carbon material is within the range of 150° C. to 280° C., and the relationship between the contents of the primary quinoline insoluble material and the ash, and the content of the metal particles comprised in the amorphous carbon material satisfies Equation 1 below, reversible capacity, charge and discharge efficiency, and output characteristics of the secondary battery may be more improved:

$$3.7 < 1 oz ( \frac{M ( wt \% ) \times 60}{QI ( wt \% ) \times Ash ( Wt \% )} ) < 9.18 \\ ( M \text{:} Metal Particle , QI \text{:} Primary Quinoline Insoluble Material ) . \qquad [ Equation 1 ]$$

Although one exemplary embodiment of the present invention has been explained, those skilled in the art will appreciate that the present invention may be variously modified and changed by additions, modification, deletion, substitutions, and the like, of components, without departing from the scope and spirit of the invention as disclosed in the accompanying claims. Accordingly, such modifications should also be understood to fall within the scope of the present invention.

### DETAILED DESCRIPTION OF MAIN ELEMENTS

100: GRAPHITE CARBON MATERIAL
200: COATING LAYER
300: METAL PARTICLES

1. An anode active material comprising:
a graphite carbon material; and
a coating layer in which an amorphous carbon material comprising metal particles is coated on a surface of the graphite carbon material,
wherein contents of the metal particles, a primary quinoline insoluble material, and ash comprised in the amorphous carbon material satisfy Equation 1 below:
$$3.7 < 1 oz ( \frac{M ( wt \% ) \times 60}{QI ( wt \% ) \times Ash ( Wt \% )} ) < 9.18 \\ ( M \text{:} Metal Particle , QI \text{:} Primary Quinoline Insoluble Material ) . \qquad [ Equation 1 ]$$

2. The anode active material of claim 1, wherein the graphite carbon material is one selected from the group consisting of natural graphite, artificial graphite, graphitized coke, graphitized carbon fiber, graphitized mesocarbon microbead, and any mixtures thereof.

3. The anode active material of claim 1, wherein the coating layer is formed by dispersing the metal particles in the amorphous carbon material.

4. The anode active material of claim 3, wherein the metal particle is one selected from the group consisting of chromium, tin, silicon, aluminum, nickel, zinc, cobalt, manganese and any mixtures thereof.

5. The anode active material of claim 3, wherein the metal particle has a diameter of 20 nm to 100 nm.

6. The anode active material of claim 3, wherein the metal particles are dispersed in the amorphous carbon material by using a dispersant, the dispersant being selected from the group consisting of polyacrylic acid, polyacrylate, polymethacrylic acid, polymethyl methacrylate, polyacrylamide, carboxymethyl cellulose, polyvinyl acetate, polymaleic acid, polyethylene glycol, polyvinyl-based resins and any copolymers thereof.

7. The anode active material of claim 3, wherein the metal particles are dispersed in the amorphous carbon material by using a block copolymer comprising blocks having high affinity with the metal particles and blocks having low affinity with the metal particles.

8. The anode active material of claim 1, wherein the amorphous carbon material is one selected from the group consisting of petroleum pitch, coal pitch, chemical pitch, and any mixtures thereof.

9. The anode active material of claim 1, wherein the content of the ash of the amorphous carbon material is less than 0.05 wt %.

10. The anode active material of claim 1, wherein the contents of the metal particles and the amorphous carbon material are 1 wt % to 30 wt %, based on the graphite carbon material.

11. An anode for a secondary battery in which an anode slurry is coated on an anode current collector, the anode slurry comprising the anode active material of claim 1; a binder; and a thickener.

12. A secondary battery comprising the anode for a secondary battery of claim 11.
